(19) United States
(12) Patent Application Publication
(10) Pub. No.: US 2002/0165707 A1
(43) Pub. Date: Nov. 7, 2002

(54) Methods and apparatus for storing and processing natural language text data as a sequence of fixed length integers

(76) Inventor: Charles G. Call, Boston, MA (US)

Correspondence Address: CHARLES G. CALL, 68 HORSE POND ROAD, WEST YARMOUTH, MA, 02673-2516, US

(21) Appl. No.: 09/793,267

(22) Filed: Feb. 26, 2001

(51) Int. Cl. G06F 17/28

(52) U.S. Cl. 704/2

(57) ABSTRACT

A mechanism for more rapidly processing natural language text data and more compactly storing such data in a memory array of 16-bit integers, each integer identifying an individual term in the text data stored in a term lookup table. The original text is parsed into a sequence of substrings consisting of alternating alphanumeric terms and intervening punctuation strings. Each substring (with the exception of a single space between adjacent alphanumeric terms) is translated into an identifying integer placed in the memory array. To perform the conversion of each term into its identifying integer, a term lookup table is searched for a previously stored term which matches the given term and, if a matching term is found, the said given term is converted into the integer which identifies the matching term. If a previously stored matching term is not found, the given term is stored in an available empty location in the term first lookup table and is converted into the integer which addresses that available empty location. High-speed term-to-integer conversion is performed using a vectored binary tree as the term lookup table. High speed searches are performed by scanning the memory array for integers which identify target words, and additional lookup tables which are also addressable by an given term's identifying number may be employed to determine attributes of that term. A text file manipulation program employs the integer array text data to rapidly search, display, categorize, annotate, and highlight the text of a natural language text database. Highlighted passages are specified by their starting and ending positions in the integer array and are characterized by stored data which specifies the highlight color, annotation text, and one or more category codes associated with the highlighted passage. A keyword in context listing may be displayed which presents a sorted list of all phrases beginning with any term in a user-specified term list.

### CROSS REFERENCE TO RELATED APPLICATION

This application claims the benefit of the filing date of U.S. Provisional Application Serial No. (unassigned—Attorney Docket A-35) filed on Dec. 15, 2000.

### REFERENCE TO COMPUTER PROGRAM LISTING APPENDIX

A computer program listing appendix is stored on each of two duplicate compact disks which accompany this specification. Each disk contains computer program listings in the Pascal programming language which illustrate implementations of the invention. The listings are recorded as ASCII text in IBM PC/MS DOS compatible files which have the names, sizes (in bytes) and creation dates listed below:

| File Name | Bytes | Created |
|---|---|---|
| XML .PAS | 3,794 | 02-17-01 |
| ABOUT.PAS | 508 | 02-15-01 |
| ANNOTATIONS.PAS | 737 | 02-15-01 |
| DATADEFS.PAS | 7,097 | 02-15-01 |
| MAIN.PAS | 35,076 | 02-15-01 |
| MEMDATA.PAS | 17,715 | 02-17-01 |
| NUMS.PAS | 5,872 | 02-15-01 |
| PAGE_DISPLAY.PAS | 19,377 | 02-15-01 |
| PROGRESS.PAS | 1,109 | 02-15-01 |
| FORM1.TXT | 61,682 | 02-24-01 |
| SESSION.PAS | 9,275 | 02-15-01 |
| TEXTWORK.PAS | 41,085 | 02-15-01 |
| DEMO.DPR | 673 | 02-21-01 |

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to electronic data processing systems and more particularly, although in its broader aspects not exclusively, to methods and apparatus for storing and transmitting text data and for performing processing operations on such data.

### BACKGROUND OF THE INVENTION

Natural language text data that is processed by computers is most commonly represented as a sequence of binary values each of which represents a character or symbol used in the visual representation of the language.

The widely used ASCII coding represents each of the commonly used letters, numbers and punctuation characters in English language text using 7-bit binary values which represent printable characters (upper and lowercase letters, numerals, and punctuation characters) and control codes (“control characters”) such as linefeed (LF) and escape (ESC) characters. To provide adequate capacity for the much larger number of characters and symbols used by other languages, the Universal Character Set (UCS or ISO 10646) and Unicode character set (a standard promulgated by the Unicode Consortium) define tens of thousands of characters. These more robust character sets typically encode characters and symbols into 16 bit codes and, as a consequence, require even more storage space per character.

Such character based coding schemes for representing natural language text data are notoriously inefficient. Thus, when large files of character text need to be stored or transmitted, text compression programs are frequently employed to make better use of storage space or reduce the bandwidth needed for transmission. Using compression algorithms such as Huffman coding and Ziv-Lempel coding, it is possible to reduce the size of text character files to a small fraction of their original size. The compressed text must, however, be decompressed before it can be processed or displayed for human consumption.

Many common operations which are performed on character data require character-by-character processing which is computationally burdensome. Two of the most common text processing operations, searching and sorting, require that character-by-character comparisons be performed repeatedly many times.

### SUMMARY OF THE INVENTION

It is therefor an object of the present invention to represent natural language text data consisting of a sequence of characters in a more efficient compressed format which requires less storage space and needs less transmission bandwidth, and which can be more rapidly processed than character data.

It is a further object of the invention to store variable length character data in an addressable array of integer values organized to permit more efficient execution of processing functions of the type typically performed by data processors.

In accordance with a feature of the invention, character data which represents natural language text is converted to a more efficient compressed form by first parsing the text data into logical subdivisions consisting of the alphanumeric terms and the intervening punctuation. Each such subdivision encapsulates the meaning of the original character text, and is represented by fixed length numerical integer value, thus forming a sequence of fixed length integers representing the original text.

The data size of each integer (preferably 16 bits) is smaller than the corresponding text it represents (e.g. a typical English language term averaging about seven characters in length plus a following space). The sequence of integers thus typically occupies considerably less than one-half the memory space occupied by the original character text. Moreover, as the total size of character based text data in the database grows large, the relative size of the vocabulary of different terms and punctuation strings stored in associated string table(s) becomes even smaller, as each term on average appears more often, making the storage technique even more efficient for larger files.

Because the integers have a fixed length and each integer has independent meaning, the sequence of integers can be much more rapidly processed than the original file of characters. For example, to search a document of one million terms for the term “Boston”, a character search would require the inspection of about eight million characters, whereas the same search through an array of a one million 16-bit integers can be performed much more rapidly by using an fast indexed array search.

The integer data can be efficiently saved in a mass storage device, such as a magnetic hard disk, and can be read, as a block, directly into RAM for processing without decompression. Because specific data may be rapidly and directly located in the random access integer array, the creation and maintenance of the directory structures normally needed to achieve high speed text searching is typically unnecessary. For example, four megabytes of text data are compressed to two megabytes or less of integer data, rather than doubled in size to eight megabytes by creating inverted index files. Thus, a four to one size advantage is achieved while, at the same time, improving search speeds and eliminating the significant computational burden required to rebuild the index files each time the text data is modified.

These and other objects, features and advantages of the invention will be better understood by referring the to following detailed description. In the course of this description, reference will frequently be made to the attached drawings.

### BRIEF DESCRIPTION OF THE DRAWINGS

FIG. 1 is a block dataflow diagram illustrating the mechanism for converting character text data into an array of integers and an accompanying term table, and for converting this stored data back into text form;

FIG. 2 is a data structure diagram illustrating the components of the pre-allocated vectored binary tree structure used to store term data and convert text data (in both directions) between its character string and integer representations;

FIG. 3 is a data structure diagram which shows the indexed tables used to perform searching and sorting of text in its integer form;

FIG. 4 is a block diagram of the principle components of the Flash-Text™ application program which implements the invention;

FIG. 5 illustrates the screen display produced by the application program's text display interface;

FIG. 6 shows the screen display produced by the application program's interface for creating and modifying highlighted passages and associated user-entered comments and subject matter category codes;

FIG. 7 depicts the screen display presented by the application program's term searching and KWIC (Key Word in Context) display mechanisms; and

FIG. 8 shows the screen display produced by the application program's proximity search mechanism.

### DETAILED DESCRIPTION

The mechanism for representing natural language text as the combination of one or more string tables and a sequence of fixed length integers may be used to advantage in a variety of applications. The computer program listing appendix includes a listing named textwork.pas which contains a Pascal language listing named textwork.pas, a Pascal unit which includes the definition of an object class named “termstore” and its descendant class “texthandler.” The termstore and texthandler objects illustrate practical applications of integer array text representation contemplated by the invention. These object classes enable natural language text in an ASCII text file to be converted into the combination of a string table and an array of integers, both of which may be persistently stored together in a newly created file which is typically less than half the size (in bytes) of the original ASCII text file.

To avoid confusion, as used in this specification, unless otherwise apparent from the context, the terms “integer” and “word” are both used to refer to fixed length numerical binary integer values stored memory arrays or files. In contrast, natural language text “words” that are composed of alphanumeric characters, as well as the punctuation character strings that appear between them, will be referred to as “terms.” As contemplated by the invention, natural language text is parsed into a sequence of character substrings (“terms”) consisting of alternating alphanumeric terms and the punctuation terms which separate the alphanumeric terms. Each parsed substring (“term”) is then converted by a table look-up operation into a binary data value (e.g., a sixteen bit “word” or “integer”) to form an array of integers (binary words) representing the original natural language text.

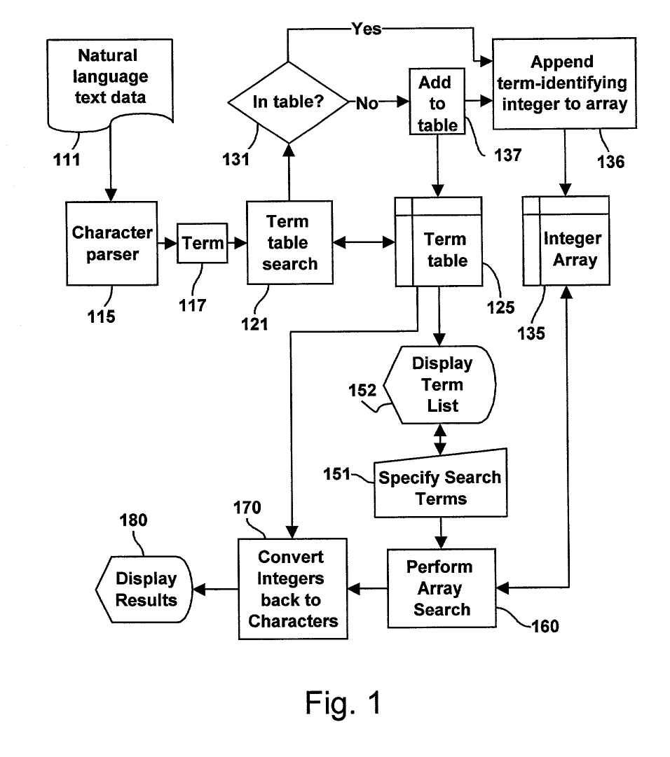

FIG. 1 of the drawings provides an introductory overview of the apparatus and methods used to represent natural language text in more compact form as an array of fixed length binary integers which may be more rapidly searched, sorted and processed. Natural language text data in a conventional file, string or character array as seen at 111 consists of a sequence of encoded text characters. The character text 111 is first parsed at 115 to subdivide the text data into substrings. The substrings (“terms”) produced by the parser at 117 consist of an alternating sequence of alphanumeric terms (normally composed of the letters of the alphabet and numerals) and “punctuation” terms each consisting of one or more spaces, punctuation marks and/or control characters such as tabs and carriage-returns. As described in more detail below, punctuation terms never include alphanumeric characters or numerals, but alphanumeric terms may include selected punctuation characters.

As shown in FIG. 1, each term identified by the parser 115 is compared at 121 with the content of a lookup table 125. The lookup table 125 preferably takes the form of a binary tree data structure which permits new terms to be dynamically added to the table while, at the same time, allowing the previously stored terms to be efficiently searched and matched against incoming terms from the parser.

In the source code listing appendix, this binary tree lookup table is implemented by the object class named termstore in the file named textwork pas. The object class termstore exposes a function named termnum which accepts a term (substring) as an input parameter, performs a binary search for that term in a table of previously stored terms, and returns the integer which specifies that term if it has already been stored. If the supplied term has not been previously stored, the function termnum assigns the next available unused integer value to the new string, stores the new string in the term table, and returns the newly assigned number.

This process is illustrated in FIG. 1 by the branching test at 131 which indicates whether or not each substring from the parser 115 is already present in the term table. If present, the integer already used to identify that substring is appended to end of an array of integers 135 as illustrated at 136. If 11 the substring from the parser 115 has not previously been placed in the term table 125, it is added to the table as shown at 137 and the newly assigned integer is appended at 136 to the end of the integer array 135.

Thus, at the conclusion of the parsing and storage process, the term table 125 holds one copy of each unique substring (both alphanumeric terms and punctuation terms) that appeared in the original text data 111, and the integer array 135 holds an integer representing each term produced from the parser 115 in the order found, with one exception. For more efficiently storage, single spaces between alphanumeric spaces are not represented. Whenever a parsed punctuation term is a single space, that single space is simply ignored and not tokenized. Whenever two integers representing alphanumeric terms occur in sequence in the integer array 135, the missing single space character is restored by logical processing and hence need not be physically stored. In practice, eliminating the integer which would otherwise be required to indicate single space that normally exists between alphanumeric terms reduces the resulting size of the integer array by nearly one-half.

After the original character-based text has been converted into more compact form as the memory array of integers 135 and the term lookup table 125, processing operations can be more rapidly performed. The integer array and term table may be persistently stored in less space on a mass storage device than originally occupied by the character data. The more compact text representation can be transmitted via a communications network of given bandwidth in less time. Perhaps most importantly, the text data in integer array form can be more rapidly processed than character data.

As seen in FIG. 1, and described in more detail below, the user can specify and view an alphabetical listing of terms in the term table 125 as seen at 151 and 152. The user can then perform a search for the desired search terms by scanning the integer array 135 for the presence of integers which specify the desired terms as shown at 160. The text identified as a result of this search can be converted back into human-readable character text by translating each integer in the selected portion of the array 135 back into its character string form using the term lookup table 125 as shown at 170, with the results being shown on a display 180 or other wise used for further processing. As will be better understood from the description which follows, text processing operations such as searching, sorting, classifying text, controlling the display of text on the monitor, and the like occur by processing the data in the integer array and in the term table, rather than by processing text data one character at a time in conventional fashion.

Text Parsing

In the Flash-Text™ program detailed in the appendix, text parsing is performed by the method named parsetext exposed by the object class texthandler, a descendant of the termstore class. The parsetext method accepts a pointer to the integer array into which the integers identifying the substrings are to be stored. Additional supplied parameters specify the location of the first available space in the integer array at the time parsing begins, the memory location of a character array (string) in memory which holds the text to be parsed, and the location of the beginning and ending positions within the character array which contain the text to be parsed.

The parsetext method separates the natural language text into alternating alphanumeric characters terms and intervening punctuation terms. First, sets of characters may defined as follows:

| Set | Members |
|---|---|
| leadset | [′A′. . . ′Z′, ′a′. . . ′z′, ′0′. . . ′9′, ′′, ′#′, ′$′] |
| midset | [′A′. . . ′Z′, ′a′. . . ′z′, ′0′. . . ′9′] |
| endset | [′.′, ′,′]; |
| trailset | [′A′. . . ′Z′, ′a′. . . ′z′, ′0′. . . ′9′, ′%′] |

The parsetext method examines each character in the input text string in sequence and identifies alphanumeric terms in accordance with the following rules: each alphanumeric term must begin with a character in leadset, and must have a character in midset at all positions thereafter except the for the last trailing character which must be in trailset, with one exception: a single character in endset is permitted to be imbedded in the term, but two endset characters in a row are not permitted, nor is an endset character permitted as the first or last character in a term. Thus, all of the following strings are all valid alphanumeric terms:

| | |
|---|---|
| Jones, J | 37% |
| $123.45 | Flag23 |
| Mary | J. Doe |
| #123 | Q23 |

Parsing is accomplished by scanning the incoming text for a character in leadset, processing the characters thereafter to insure that they continue to obey the rules for the content of an alphanumeric term, and then treating the characters thereafter as punctuation until another leadset character appears.

The selection of the specific characters included in each of the various sets is a design choice that may be varied in different applications. For this reason, the texthandler object, which is a descendant of the termstore object, is a separate object derived from (and inheriting the features of) the termstore. Different text handlers can be derived from the termstore class to define different parsing mechanism to be used. The leadset could be expanded, for example, to add the underlined character ‘_’ or the colon ‘:’, both of which are commonly used to as acceptable leading characters in programming languages. The endset could similarly be expanded to include the hyphen ‘-’, the colon ‘:’, and the slash marks ‘/’ and ‘/’ to join the substrings of hyphenated terms, qualified names joined by a colon, and full pathnames.

Character data which conforms to a markup language, such as HTML or XML, may be first parsed by the appropriate markup parser to subdivide the data into markup data and character data. The markup data may then be encoded in a suitable compact format, and the natural language character data may be parsed using a parsing technique of the type described above and represented as an integer array and a term table. Also, the original natural language text data may be stored in one or more fields of a flat file or relational database, or in anyof a number of other forms. It should therefor be understood that the mechanism for representing character based natural language data as an array of fixed length integers and a table table may be applied to advantage regardless of the source of the original text data and regardless of the storage location (record, file, database field, etc.) of the integer array and term table.

It should also be noted that altering the manner in which alphanumeric terms and punctuation of natural language text is parsed by changing the makeup of the sets can optimize the degree to which compression is achieved without seriously affecting the ability to locate specific terms by performing token searches. A search can be performed for any string by comparing that string with the contents of any stored term to identify a set of stored terms which begin with, include or end with that string, as exemplified by the search mechanisms used in the Flash-Text application program as described below.

Term Storage Using a Binary Tree

In order to tokenize the terms generated by the parsing method described above, a mechanism is needed for comparing each term with all of the previously generated terms and returning the token that was assigned to each unique term when it first occurred. Because this search must be conducted for every parsed term, it should be efficient. Although efficient binary searches can be performed on sorted lists, it is would be computationally burdensom resort the list when every new term is encountered. Although the stored terms could be placed in a linked list, with the new term being inserted into the list at the appropriate position to avoid the need to reorder the rest of the list, a binary tree structure provides more efficient searching than the serial search needed with a linked list.

Accordingly, the storage and rapid lookup of terms is preferably implemented using a binary tree data structure. A “tree”is a data structure in which each element or node is attached to one or more elements called branches. Trees are often called inverted trees because they are normally drawn with the root at the top. The elements at the very bottom of an inverted tree (that is, those that have no elements below them) are called leaves. A binary tree is a special type of inverted tree in which each element has only two branches, one of which holds values less than the value at the parent node, and the other holds values greater than the value at the parent node.

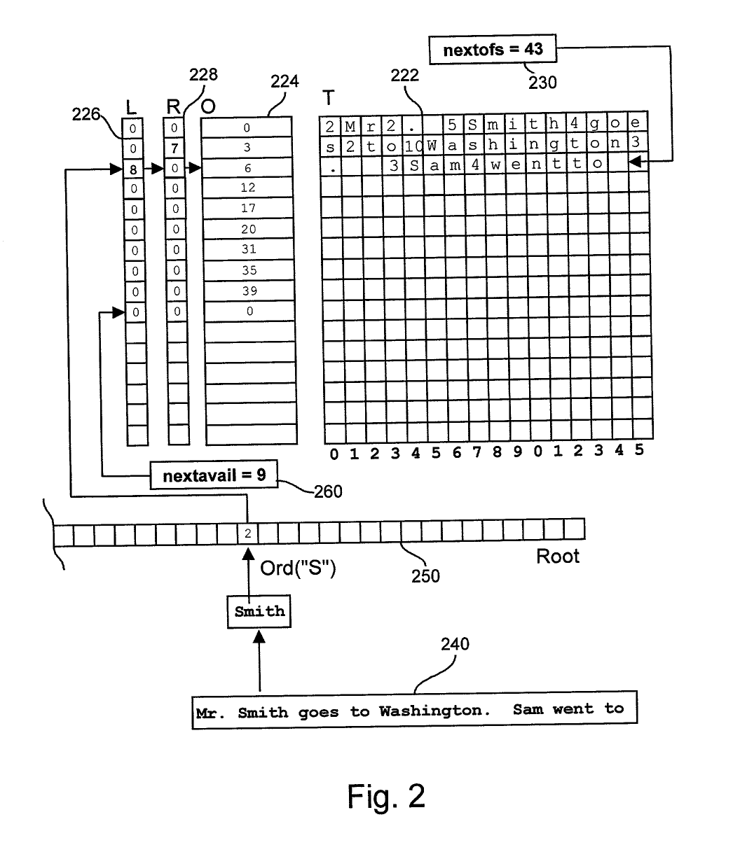

To further improve the efficiency of the process for converting terms into corresponding integer tokens, a data structure here called a “pre-allocated, vectored binary tree” is employed. This term storage structure employs five memory arrays as illustrated in FIG. 2. The characters for each stored term are placed in an array of characters named T (for “terms”)seen at 222. A table named O (for “offset”) seen at 224 holds the offset value at which each term begins in the character T array 22s. Left and right binary tree pointer arrays named “L” and “R” respectively and shown at 226 and 228. The L, R and O arrays are each indexed by a termnumber value and together form one tree node. The L and R entries for each node identify the termnumber of branch nodes, and the O array entry specifies where the characters making up the node's term are stored in the T array 222.

The function of each array might be best introduced using an example. Assume that the parsing process begins with the phrase “Mr. Smith goes to Washington. Sam went to . . . ” as indicated by the input text shown at 240 in FIG. 2. The parsing process (shown at 115 in FIG. 1) subdivides that input text into the substrings which are to be represented by the sequentially assigned termnumbers shown in Table 1 below. Table 1 also lists the length of each substring, the values placed in the binary tree L and R arrays 226 and 228 during the parsing of the input text 240, as well as the values placed in the offset array O 224 to specify the location of that substring in the character array T at 222.

TABLE 1

| Termnumber | Length | Term | L (left) | R(right) | O (Offset) |
|---|---|---|---|---|---|
| 0 | 2 | Mr | 0 | 0 | 0 |
| 1 | 2 | .[space] | 0 | 6 | 3 |
| 2 | 5 | Smith | 7 | 0 | 6 |
| 3 | 4 | goes | 0 | 0 | 12 |
| 4 | 2 | to | 0 | 0 | 17 |
| 5 | 10 | Washington | 0 | 8 | 20 |
| 6 | 3 | .[space][space] | 0 | 0 | 31 |
| 7 | 3 | Sam | 0 | 0 | 35 |
| 8 | 4 | went | 0 | 0 | 39 |
| 4 | 2 | to | 0 | 0 | 7 |

Note that the punctuation separating “Mr” (a period followed by a single space) is represented by the termnumber 1. The period followed by two spaces after “Washington” is a different term which is encoded as the termnumber 6. Note also that where single spaces separate alphanumeric terms, these single spaces are not tokenized.

Note further that the first and second occurrence of “to” are both encoded with the same termnumber 4. As the total amount of text which is parsed and tokenized increases, the probability that a given term will have already been tokenized (and hence does not require the creation of a new node) increases dramatically. As a result, the size of the termstore needed to store all of the unique terms in a large text database is typically small in comparison to the size of the original text.

During the parsing process, the content of a register “nextofs” seen at 230 is continuously updated to hold the offset location for the next available empty character space in the character array T. At the beginning of the parsing process, nextofs is initialized to the value 0. In addition, both the L and R arrays are initialed to all zero values. When the first term “Mr” is produced by the parser, it is placed in the character array T as the character string “Mr” with a leading size byte value 2 at the location 0 specified by the content of nextofs, and nextofs is incremented by 3 to point to the next available empty space.

Pre-Allocation

While it would be possible to store the L and R pointer information together with the term string in a separately allocated node object, less space is consumed and more rapid processing is achieved by pre-allocating blocks of memory space for the L, R, O and T arrays in advance, and then using the nextavail and nextofs registers to specify the next available location for a node when a new term is to be stored. It may be further noted that the size of a character string in T could be calculated by subtracting the offset value in the O array from the offset value for the next term, eliminating the need for storing a size byte in the array 222. For processing efficiency, however, it is convenient to be able to reference and manipulate the strings stored in the T array 222 as “shortstrings” with a leading size byte. Moreover, the inclusion of the size byte with each term makes in possible to store only the contents of the T array 222 with a single block write operation to mass storage, and to restore the termtable with a single block read operation. After the block of shortstrings is loaded into memory, the contents of the L, R and O arrays may be readily reconstructed. See the save_to_file and load_from_file methods exposed by the termstore object in the unit textwork.pas for details.

If the text data is stored as a read-only file, the need for the L and R pointer arrays can be eliminated by sorting the terms in the T array 222 into alphabetical order, while building a table that converts the original term number into a new termnumber indicating the terms new position in the sorted order, and then using this conversion table to substitute the new termnumber for the old termnumber in the data array. Terms can then be displayed in sorted order, a binary search on the sorted list may then be performed to convert strings to term numbers. In the preferred embodiment disclosed, however, the binary tree structure is retained to permit new text data to be efficiently added to the text database.

Vectored Binary Tree

To speed tokenization (the conversion of term substrings into the termnumbers representing those substrings), a separate tree is created for all terms beginning with the same character. The array Root seen at 250 is indexed by the ordinate (binary byte value) of the first character of each term. For example, the ASCII byte code value for the capital letter “S” is decimal 65. When the term “Smith” was parsed, it was the first term encountered that began with the capital-S character as indicated by a zero value at root[65].

Since it is known that this is the first occurrence of the term “Smith” or any other term beginning with “S”, the character string “Smith” is placed in the T array 222. The size byte value 5 (the length of “Smith” in characters) followed by the characters “Smith” are placed in the T array 222 beginning at the offset location 6 (as specified by the current value of nextofs, which is then incremented by 6 to point to the next available empty cell in the T array 222). Since this is the first occurrence of “Smith”, it is assigned the next available wordnumber 2 as specified by the content of the register nextavail (seen at 260), and nextavail is incremented by one. The wordnumber 2 acts as a pointer to the offset O array 224. The character table offset location value 6 is inserted into the O array 224 at cell O[2] to indicate the location of the string value for “Smith”.

Converting Terms to Term Numbers

Thus, any termnumber may be converted into its corresponding string by using the wordnumber to index the cell in the offset O table 224 which contains the location of the string in the character array T at 222. This simple conversion may be performed by the following numterm method that is implemented a single Pascal assignment statement:

function TermStore.numterm(const n: word) : shortstring;
begin

numterm:=shortstring(T[O[n]]);

end;

Stated in English, the wordnumber n (a 16 bit Pascal word) is used as the index to the O array to obtain O[n], which is then used as the index to the cell in the T array which holds the beginning of the shortstring represented n.

Because the term “Smith” is the first occurrence of a term beginning with the character “S” its assigned wordnumber 2 is placed in the root table at the cell indexed by the ASCII code value of “S”;

that is, at root[65]. Therafter, when the term “Sam” is encountered, the value 2 in root[65] inform the process that one more previous terms beginning with “S” have previously been stored and are found in a binary tree beginning with the root location pointed to by root [65]=2.

The use of the root table 250 to store the root wordnumber of each of the 255 different possible binary trees substantially increases the speed with which searches can be conducted. The use of the root table limits the search required to only the terms beginning with the same letter, and can save as many as eight binary tree tests for each search, thus substantially speeding search operations by narrowing the field of search to only those terms which begin with the same letter. Sorting Terms and Text expressed as Integers The vectored binary tree used in the preferred embodiment of the invention can also provide a sorted listing of terms in alphabetic order. A recursive routine called dump is used to walk through each binary tree, transferring termnumbers in sorted order into the result array called sorted, as illustrated by the following routine.

var j: integer; { index to sorted: array[0..max] of termnumber }
procedure dump(p: word) ;
begin

if p <> stop then
begin

dump (left[p]) ;
sorted[j] :=p;
inc(j) ;
dump (right[p])

end

| | |
|---|---|
| end; | { recursively transfer in sorted order } |

Because the terms actually exist in separate trees, each stemming from a vector in the root array, the full list of terms is placed in the sorted array by calling dump to recursively list the contents of each subtree in alphabetical order, as illustrated below.

for i:=0 to 255 do

if root[i] <> stop then dump(root[i]) ;

See also, the method sortterms in the termstore object program listing for additional details.

In many text searching systems, a problem arises when the original data is improperly entered. Thus, the search of a text file for the string “telephone” will not identify the terms “telephome” or “telefone”. Because all of the terms in the termstore can be readily displayed to the user in alphabetical order, the user can simply first request a listing of all terms beginning with the letters “tele” which would reveal the variations which the user can include or exclude from the search. This capability is used is the illustrative Flash-Text™ program to be described to enable the user to easily identify all of the variations of a given term that may exist in the stored text by specifying a string of characters and performing a search of all terms that begin with, include, or end with the characters in the specified string.

It is also useful to know the number of times each term appears in the database. That can be accomplished using a procedure like the one illustrated below which populates an array called count:

var count: array[0..maxnum] of integer;

fillchar(,sizeof(tableA),0); {zero all cells of table A}

for j:=0 to topdata do inc(tableA[Data[j]);

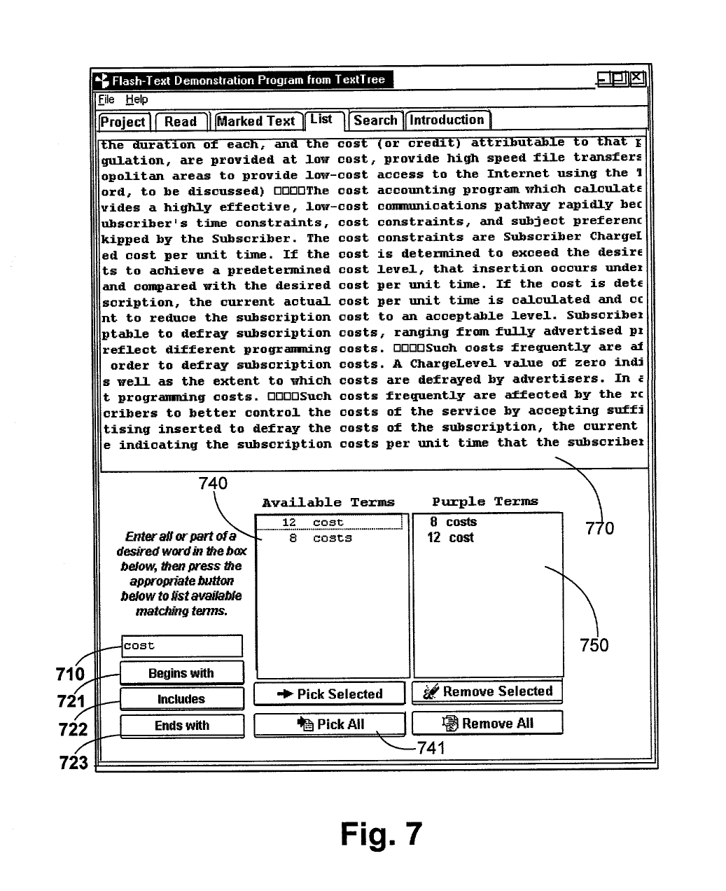

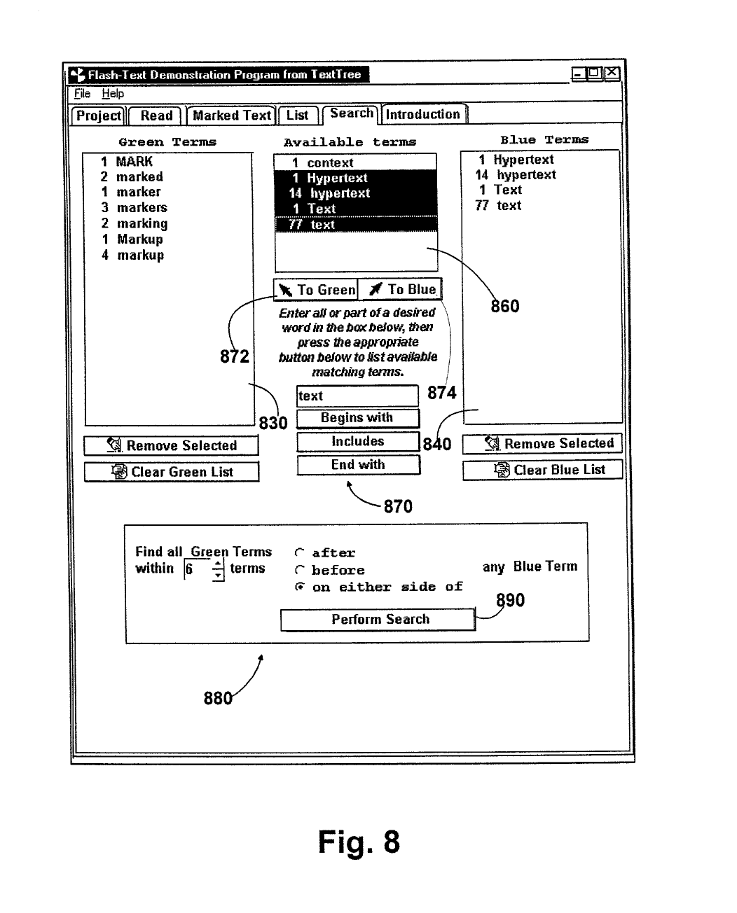

The routine above scans the Data array and places a value at each location count[n] which indicates the number of times the term numstring(n) occurred in the text. This count can then be displayed with the termlist to facilitate the formation of search requests. The Flash-Text™ program to be described displays the number of times any term occurs in the text data as a guide to the user (see the list boxes at 740 and 750 in FIG. 7, and at 830, 840 and 860 in FIG. 8, to be described).

Text represented by a sequence of one or more integers may be rapidly sorted by first using a routine of the type shown above, with the statement in the recursive dump routine reading “sorted [j ]:=p;” being replaced with the statement “sorted [p ]:=j;”. This change loads the array sorted with values indexed by termnumber which indicate the position of the corresponding term in the sorted order. This makes it possible to compare two termnumber to determine which one identifies the term which would occur first in sorted order. Thus, if a and b are term numbers and sorted[a]<sorted[b], then the term specified by a occurs in sorted order before the term specifed by b. Conventional sort routines, such as the QuickSort method used by the Delphi library tlist object, typical use an external compare function of the following type:

type TListSortcompare=function (Item1, Item2: Pointer): Integer;

which is to be programmed to return an integer <0 if Item1 is less than Item2, 0 if they are equal, and >0 if Item1 is greater than Item2. The following function accordingly permits the tlist object's sort method to sort a collection of text items each represented by an integer (word) array:

type pia: array[0..maxnum] of word;
function IntegerTextCompare(Item1, Item2: pointer) : integer;
var j: integer;
begin

j:=0;
While pia(item1)[j] = pia(item2)[j] do inc(j) ;
a:=pia(item1)[j] ;
b:=pia(item2)[j] ;
if sorted[pia(item1)[[j]] < sorted[pia(item2)[[j]] then result := −1
else result:=1;

end;

Note that the IntegerTextCompare function compares entire terms on each test, rather than comparing text characters one at a time.

In the Flash-Text program detailed in the program listing appendix, the Keyword and Context Listing is sorted using a case insensitive sort (see the compare function named kwicsort listed it textwork.pas unit). This function first makes a case insensitive comparison between each pair of terms and, if the terms match when case is ignored, then performs a case sensitive comparison between the terms. This comparison produces a sorted listing that groups terms having the same spelling together regardless of capitalization in the way the user would expect from an alphabetical listing, but also groups capitalized and uncapitalized versions together for ease of reference when the case may have significance.

Fast Search Mechanisms

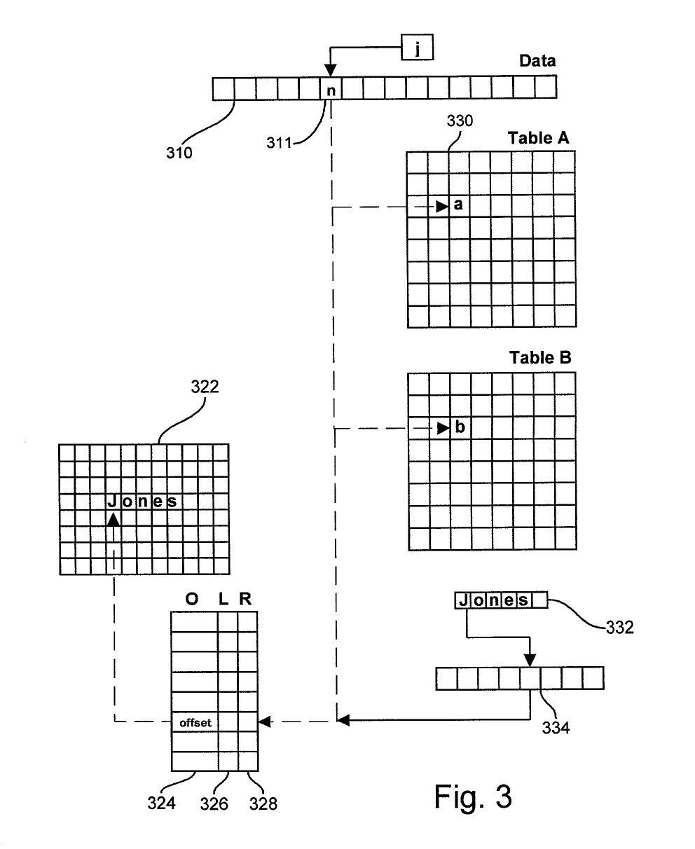

The representation of natural language text as a sequence of tokens which represent language alphanumeric terms and intervening punctuation as contemplated by the invention permits very fast text searches to be performed using array-based logic. This mechanism is illustrated by an example shown in FIG. 3 of the drawings.

In FIG. 3, an array of integers (numerical tokens) is shown at 310. The array 310 holds the sequence of integer values which correspond to the sequence of terms in the original natural language text. The array 310 is identified by the symbolic name “Data” and comprises an array of fixed-length 16-bit binary words indexed so that the value Data[j] (the value in the array cell 311 at the index location j in the array 310) can be retrieved by a simple array lookup function; that is, as expressed in Pascal, n:=Data[j].

If it is desired to search the Data array 310 for the term “telephone,” the token value of the term “telephone” can be fetched from the termstore using the function termnum(‘telephone’). If the last cell in the array Data is indexed by the value “datatop,” the execution of the following simple code statements performs the desired high speed search:

target:=termnum(‘telephone’);

for j:=0 to datatop do if Data[j]=target then hit_handler(j);

The routine above passes j, the location of the target integer, to the utility procedure hit_handler which processes the result as desired.

A high speed search can also be performed for any one of a large number of different terms.

For example, the user may wish to search the text for any term matching any one of the following terms:

| | | | |
|---|---|---|---|
| telephone | Telephone | telephones | Telephones |
| phone | Phone | phones | Phones |
| cellphone | Cellphone | cellphones | Cellphones |

All of these terms, if used in the text data, can be listed simply by searching the termtable for all terms including the string “phone”. To perform a high speed search, a second lookup table A seen at 330 in FIG. 3 is employed. The table A may take the form of an array of byte locations of the type declared by the following Pascal statement:

type TableA: array[0.maxnum] of byte;

Before the search is started, table A is initialized with zero values in all cells except the cells which are addressed by the integers which identify one of the terms in the list of target terms. Thus, if the group of words is placed in an array of strings called wordlist, the following statements properly initialize table A:

fillchar(TableA, sizeof(tableA),0); { zeroes all cells in TableA }

for i:=0 to 1 do TableA[termnum(wordlist[i])):=1;

The second statement places a 1 value in each cell of TableA which is addressed by the termnumber that identifies one of the terms in the wordlist.

After the second lookup tableA is initialized, the search of the Data array for any term that matches one of the terms in the wordlist is performed by compiling and executing the following Pascal statement:

for j:=0 to datatop do if TableA[Data[j]]=1 then handlehit(j);

Where datatop is the last cell of Data which holds a termnumber, and handlehit is a utilization procedure that processes those j values which identify the locations in the Data array which hold a termnumber identifying one of the target terms in wordlist.

The program Flash-Text™ to be described provides a more detailed example of this technique of addressing a second array using the term numbers from the data array to identify any of a potentially large group of target words. As also illustrated by the Flash-Text™ program, lookup tables addressed by the termnumbers which tokenize terms can be used to provide other kinds of high speed processing, including the display of selected terms in special fonts and the identification locations in the text having predetermined attributes such as line endings and tab characters.

Proximity Search

Because the location of individual terms can specified by a single offset value in the data array, it is possible to readily designate terms and term sequences. This characteristic may be used to advantage to perform proximity searches. For example, assume a “proximity” search is to be made for any occurrence of any one of thirty terms in WordListA within six terms prior to any one of twenty terms in WordListB. Such a search can be performed as follows:

var i,j,ax,bx integer;
ax:=−999; bx:=−999; { initialize two variables}
fillchar(TableA,sizeof(TableA),0); { zero TableA}
fillchar(TableB,sizeof(TableB)1,0); { zero TableB}
for i:=0 to 29 do TableA[termnum(WordListA[i] :=1;
for i:=0 to 19 to TableB[termnum(WordListB[i]:=1;
for j:=0 to datatop do

if TableA[Data[j]] = 1 then ax:=j else

if TableB[Data[j]] = 1 then

if (j−ax) < 7 then handle_hits(j,ax) ;

where handle_hits is a routine which provides appropriate processing for the text beginning with the occurrence of a term in WordlistA at Data[ax] and ending with the termnumber at location Data[j] which identifies a term in WordlistB. This technique is used to implement the proximity searching capability used in the Flash-Text™ program as depicted in FIG. 8 to be described.

Weighted Search

The array processing technique can be used to perform weighted “fuzzy” searches. For example, the user may perform a preliminary search, obtain a trial listing of items which match one or more search terms, and then select an particular one of the displayed item which appears to be of particular interest. The user may then perform a second weighted search for those items in the database which are “most like” the selected item.

First, using the procedure noted above, count values for all of the terms in the database can be placed in the tableA seen seen at 330 in FIG. 3. Next, table B is zeroed, and thereafter all of the terms in the user chosen “best” item can be scanned and each token value used to place a weight value in the corresponding cell of table B using the routine of the type illustrated below.

for j:=beststart to bestend do

inc(tableB[Data[j], weightval(tableA[Data[j]]) ;

The routine above increments the value (initially zero) in each tableB cell addressed by a termnumber found in the “best item” (from Data[beststart] through Data[bestend]). The table B cell is incremented by a weight value produced by the function weightval(n) which uses the count values in table A to compute a weight value which is inversely related to the total count in the database of the occurrences of termnumber n. This is done because low frequency terms should be assigned greater significance than high frequency terms. The value in the table A cell for a given termnumber is incremented by that weigh value each time that given termnumber appears in the “best” timer, since terms which appear frequently in the “best” item should be assigned a greater weight than the terms which appear infrequently.

After the weight table B is loaded, it is merely necessary to perform the following scan of the text tokens for each item:

for ino:= 0 to lastitem do begin

itemweight:=0;
For j:= textstart(ino) to textend(ino) do

inc(itemweight,tableB[Data[j]];

KeepInTopTen(ino,itemweight);

end;

As illustrated by the pseudocode above, the individual items are designated by an itemnumber ino and each has a beginning value at the offset textstart(ino) and and ending value at the offset textend(ino) in the data array Data. An itemweight value is rapidly computed for each item consisting of the weighted sum of the significance of all of the terms in that item. The item number and its calculated itemweight is then passed to a method called KeepTopTen which keeps a list of the ten items having the largest itemweight so that those items can be displayed to the user at the end of the search. Note that this process occurs by high speed integer array addressing mechanisms and can be done performed very rapidly even for very large databases. A comparable search based on conventional character text scanning methods would typically not be attempted because of the processing burden imposed.

Termnumber Size

The 16-bit word size for termnumbers used to tokenize terms was selected for several reasons. For machine processing efficiency, the integer size should be chosen as an even multiple of the 8-bit size used in conventional byte addressable RAM. A 16-bit integer (word) permits up to 65,536 different terms to be specified in a string table, which has been found to be a vocabulary of adequate size to store all of the unique terms used in a large text database which, when convertet to tokenized form, can be stored in the available RAM space. Although a 32 bit integer size could also be rapidly processed, since most modem computers employ an ALU register size and memory bus widths of 32 bits or larger, the 16 bit integer size yields a data structure half a slarge, and the 16 bit size permits a termcount that is more than adequate for even large text databases. Because of the significant advantages resulting from storing the entire database in RAM as an integer array (particularly the avoidance of index structures which are rendered unnecessary since high speed RAM array searches can be performed more rapidly than fetching an index file from mass storage. Nevertheless, it is recognized that, as RAM memory costs continue to be reduced, a larger 32 bit integer size could substituted which would provide more than adequate address space for the largest vocabulary that might be needed.

It should also be noted that the character data stored in the term tables typically takes the form of conventional 8-bit ASCII coded characters. Database systems which support natural language text data in other languages may alternatively store “terms” as 16-bit UNICODE characters. These “wide character” strings may be tokenized in the same way using a character array of 16-bit characters rather than the array of 8-bit ASCII characters used in the example described above.

The Flash-Text™ Program

The present invention has been used to advantage in a Windows® application program called Flash-Text.™ The Pascal language source code for this program is reproduced in the computer program listing appendix which accompanies this specification. The listed programs are divided into units which were compiled using the Delphi® 5 rapid application development system produced by Borland Software Corporation, 100 Enterprise Way, Scotts Valley, Calif. 95066-3249. The following description provides an overview of the Flash-Text™ program and the manner in which the present invention is used in that program.

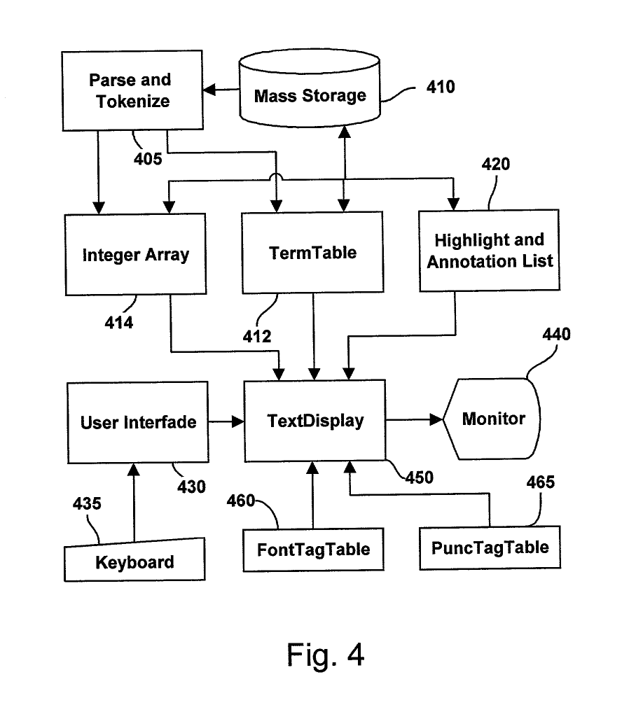

As seen in FIG. 4, the Flash-Text™ program parses and tokenizes the natural language text found any user-selected ASCII text file. The parsing and tokenization is performed as indicated at 405 by the the parsetext method of the texthandler object (in the textwork.pas unit) after the text file is read from mass storage unit 410 (typically a hard or floppy disk drive). The parsing operation produces the termtable 412 and an array of integers 414 in the computer's RAM storage. After the integer array 414 and the termtable 412 are produced, both may be saved, along with the contents of a list of highlighted passage designations and annotations seen at 420, in the mass storage device 410 for later use.

As previously described, the texthandler.parsetext method parses the ASCII characters of the natural language text into alternating alphanumeric terms and punctuation strings, employs a binary tree structure to convert each parsed substring into a numerical token, and stores the resulting integer array in RAM. The integer array 414 is managed by the a tfilenumstore object defined in the nums.pas.unit.

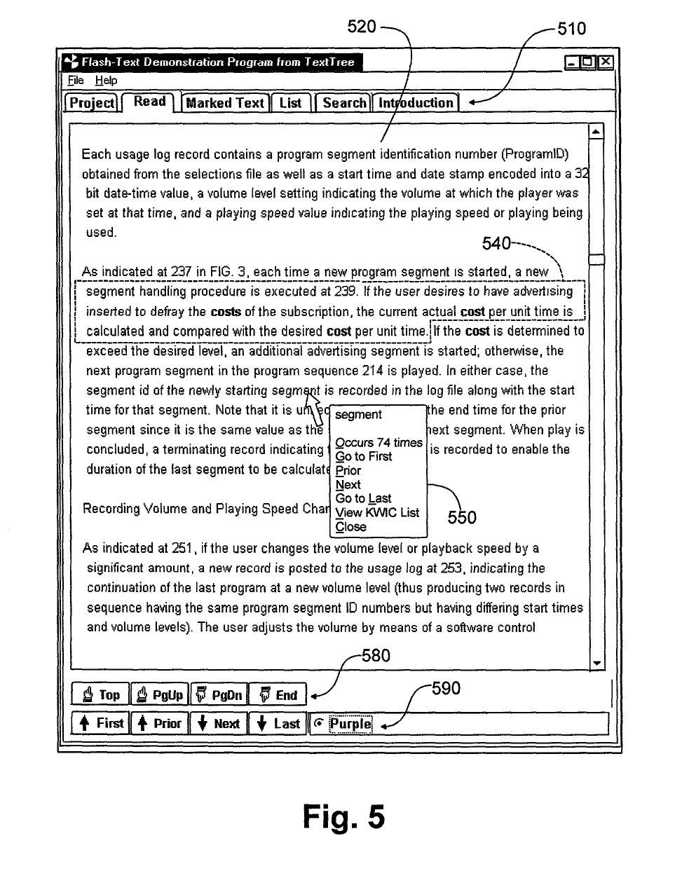

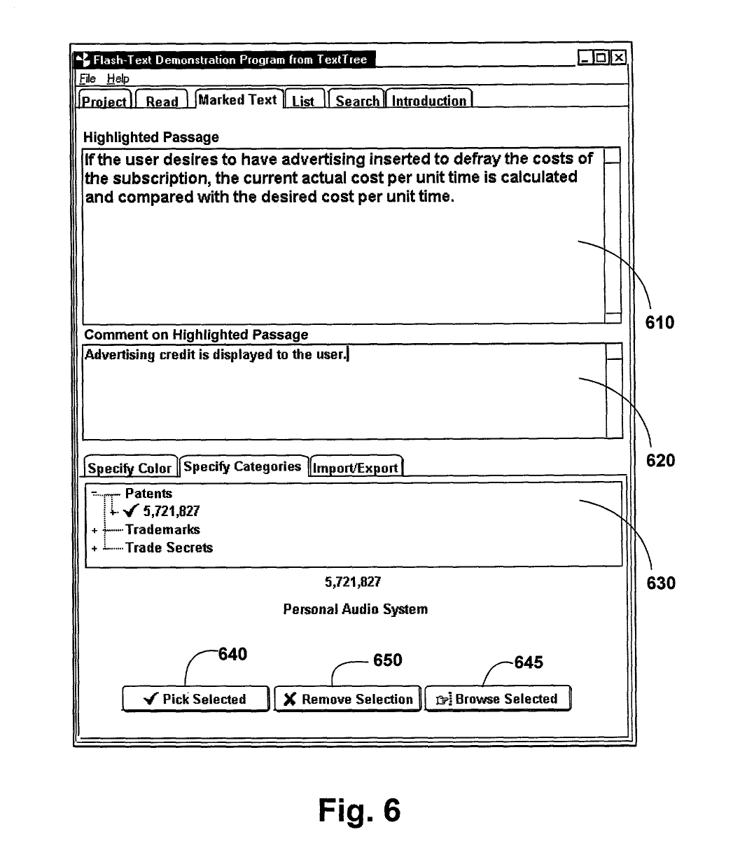

The user interface 430 for the Flash-Text™ program is provided by the Form1 object whose methods are defined in the main.pas unit. The layout or appearance of the Form1 object as shown on the screen is defined by the form1 format definition file reproduced in the accompanying appendix in the listing named form1.txt. The form1 object produces the screen displays shown in FIGS. 5-8 of the drawings following a tabbed-notebook metaphor. The tabs indicated generally at 510 near the top of the form bear the labels “Project,” “Read,” “Marked Text,” “List,” “Search” and “Introduction”. When the “Read” tab is selected by the user with the mouse, the display shown in FIG. 5 is presented. The screen layout presented when the “Marked Text” tab is selected is shown in FIG. 6. FIG. 7 shows the screen presented when the “List” tab is selected. FIG. 8 shows the screen layout displayed when the “Search” tab is selected.

The “File” option of the program's main menu permits the user to designate text files for conversion into compressed form for faster processing and for storage in the mass storage unit 410 as noted earlier, and further allows the user to designate previously compressed files and data for loading into the integer array 414, the termtable 412, and the highlighting and annotation list 420.

As illustrated in FIG. 5, the display under the “Read” tab includes a text window 520 which displays the one page of content of the compressed file directly on the monitor 440 (seen in FIG. 4) using the mechanism implemented by the textdisplay object defined in the page_display.pas unit. The textdisplay object includes a method named show_page_beginning_at_cursor which displays text directly on the screen using the Windows GDI (graphics device interface). The text displayed by this method begins with the term represented by the integer located in the integer array at the offset position specified by the variable named cursor. Each integer to be displayed as text is fetched from the array, converted into its equivalent term (string) using the termstore.numstring function listed in the textwork.pas unit, and the resulting string is written to the display in a font determined by the method write_term_at_cursor of the textdisplay object as listed in page_display.pas.

Font and Highlight Colors

The font color is determined by the content of a fonttagtable object (seen at 460 in FIG. 4) that holds an array of bytes indexed by termnumbe. Each byte value in the array indicates the font color to be used when the term specified by a given termnumber is displayed on the display 440. The font color is set by the textdisplay.set_color_for(termnumber) method before each term is displayed. As will be discussed below, the user performs search operations in various ways by placing terms of interest in one or more of three list boxes: the Purple Terms list box 750 seen in FIG. 7, the Green Term list box 830 and the Blue Term list box 840 seen in FIG. 8. The addition of a given term in one of these list boxes places a tag value at the location in the fonttagtable 460 indexed by the term number for the given term. Whenever a term number in the data is displayed in the read window 520 seen in FIG. 5, the set_color_method changes the font color for the window's canvas accordingly. As a result, the terms which are placed in these list boxes are displayed in the corresponding color so that they can be easily identified by the reader.

Whenever terms are placed in any of these list boxes, a set of navigation buttons also appears in a row below the page navigation buttons 580 at the bottom of the form under the Read tab, as indicated generally at 590 in FIG. 5, The navigation buttons seen at 590 appear next to the “Purple” radio button which is shown as being selected in 590 (indicating that terms have been placed in the Purple list box 750. As seen in FIG. 7, the terms “cost” and “costs” appear in the Purple list box 750 (see FIG. 7) and these terms accordingly are displayed in a purple, bold font in the read window 520. The navigation buttons at 590 may be manipulated to change the text displayed in window 520 so that the first, prior, next or last “purple term” in the Purple list box 750 can be seen in context in the window 520. Additional radio buttons (not seen in FIG. 5) for the green and blue terms in the list boxes 830 and 840 respectively also become visible when those list boxes are populated, allowing the user to independently browse between terms of any selected one or all of the font colors. As discussed below, any word in the text displayed in window 520 may also be selected using the mouse and placed in the Purple list box 750 as discussed below in connection with the Key Word in Context Listing interface displayed under the “List” tab.

The highlight (background) color used to display each term is set by the set_highlight_for(cursor) method of the textdisplay object (detailed in the page_display.pas unit) by determining whether or not a given integer array location holding the termnumber to be displayed is inside or outside a highlighted block of text. A list of the highlighted blocks of text is managed by the user object defined in the sessions.pas unit. Each highlighted block may have associated with it not only a user-chosen highlight color but also a user-entered comment (annotation) and one or more subject matter code categories.

Annotations and Classification by Category

Each highlighted block of text is defined by a textblock object stored in an object list of textblock objects user.block as defined in the unit sessions.pas. Each text block contains the following data:

cats: pNumPtrs;

first,last: integer;

block_color: hilite_color;

note: string;

where cats is a pointer to an dynamically allocated array of 16-bit words that holds the category codes associated with that block of highlighted text, first and last are the offset values in the integer array where the highlighted block begins and ends, block-color stores the highlight color selected by the user for that block, and note contains the text of a comment or annotation entered by the user for that highlighted block.

Thus, a contiguous sequence of integers in the integer array may be selected for highlighting by the user by manipulating the mouse to select a block of text such as the text block within the dashed-line outline 540 seen in FIG. 5. After the textblock is selected, the user is given the option of highlighting that block. If the highlight option is chosen, the view under the “Marked Text” tab is automatically displayed as illustrated by FIG. 6. The selection of a block of text on the “Read” tab screen (at 540 in FIG. 5) selects a sequence of integers in the integer array, and these integers are converted into a corresponding natural language text by the method show_block method in the form1 object which calls the astext method of the termstore object (in the textwork.pas unit) to convert the designated block of integers into text which is displayed in the Highlighed Passage window seen at 610 in FIG. 6.

The interface presented under the Marked Text tab seen in FIG. 6 includes a memo edit window 620 into which the user may enter and edit a comment (annotation) associated with the highlighted passage from the original text which is displayed in the window 610. The separate tabbed panels at the bottom of the Marked Tab display include a “Specify Color” tab which displays an interface (not shown) that includes radio buttons that allow the user to select the highlighted color to be used, and further provides navigation buttons which allow the user to go the first, previous, next, or last highlighted passage of any selected highlight color. This allows the user to quickly review all or selected ones of the highlighted passages, or to add additional notes, or to change the color of any previously highlighted passage.

In addition, as seen in FIG. 6, the user may press the “Specify Categories” tab to see a hierarchical tree list of categories at 630, and to place a check mark next to any category to which the highlighted passage belongs as illustrated by the check mark next to the subcategory “5,721,827” under the category “Patents” in the category list 630. The categories themselves are created by selecting the “Project” tab at the top of the form which displays an editable hierarchical (tree) category list (not shown) which the user may create to serve the needs of a particular research project. After the user selects a category on the category list 630 using the mouse, the “Pick Selected” button 640 may be pressed to place a check mark next to the selected category. The check mark may be removed by selecting that category again and pressing the “Remove Selection” button.

The button “Browse Selected” button seen at 645 may be pressed to display a set of navigation buttons (not seen in FIG. 6 and not visible until the button 645 is pressed), enabling the user to review prior highlighted passages and annotations which have been previously associated with the selected category. When the “Remove Selection” button is pressed again, these category navigation buttons disappear and the display returns to the highlighted passage that was displayed when at the time the “Browse Selected” button was first pressed. Note also that the “Browse Selected” button 645 is invisible when no category has been selected on the category list, or if no highlighted passage has been associated with the selected category.

Thus, the Flash-Text™ program uses the highlighting of passages to give the knowledge worker powerful tools for organizing information found in a large amount of text data. As the text is reviewed or searched, passages of interest can be easily highlighted for future reference, the user may add comments (annotations) to each highlighted passage, the highlight color can be chosen to differentiate different kinds of passages (for example, passages which suggest the need for further work might be highlighted in blue for future review, while the last read passage might be highlighted in yellow to act as a bookmark so that it can be quickly found again). A more organized categorization of passages is provide by the user created hierarchical category tree, which the user can define and which can be expanded or revised as new or different topics are needed. By classifying individual highlighted passages and annotations in one or more of the categories defined by the tree, the user can quickly find all passages which relate to the topic of interest. Importantly, the highlighted passages can be selected by category, or by highlight color, and exported for use in another program along with the entered annotations and category descriptions.

Numerous additional features of the Flash-Text™ program make it easy to locate subjects and passages of interest. These search techniques employ the termtable (seen at 412 in FIG. 4) and the high speed integer search capabilities described above.

Key Word In Context Display

When the user is reviewing text under the “Read” tab, she may use the mouse to “right-click” on any displayed term, thereby displaying a pop-up menu as seen at 550 in FIG. 5. The pop-up menu displays the selected term, the number of times that term appears in the original text, and permits the user to immediately jump to the first, previous, next or last occurrence of that term. In effect, this capability allows the user to treat ever term displayed as a hypertext link to all of the other occurrences of the term in the data. A method exposed by the textdisplay object called get_word_position converts the x and y position of the mouse cursor into the offset position in the integer array that holds the term displayed and selected by the user.

The user may also use the resulting pop-up menu box to display a “KWIC” (Key Word In Context) listing of all occurrences of the selected word using the display presented under the “List” tab which is illustrated in FIG. 8. The KWIC list interface is show in FIG. 7. This interface permits the user to select any term or set of terms and then view listing containing a line of text for each occurrence of the selected term(s). In the example seen in FIG. 6, the user has enters the term “cost” in the edit window 710 and pressed the “Begins with” button 721, causing the terms “cost” and “costs” to be listed in the “Available Terms” list box at 740, along with an indication of the number of times those terms occur. The available terms window indicates that the term “cost” occurs 12 times and the term “costs” occurs 8 times. The user chooses to see the occurrences of both terms, and presses the “Pick All” button 741 to transfer both words into the “Purple terms” list box at 750. At the same time, all of the occurrences of the selected “Purple Terms” are displayed in the KWIC list window at 770. So that all phrases that begin with a given selected term will appear together, the lines displayed in the KWIC list are sorted based on the selected terms and the terms that follow the selected terms.

All of the displays shown on FIG. 7 are produced substantially instantaneously, even with a very large text database, without the use of index files, because of the high speed search that can be made of the array of tokenizing integers. First, the display of available terms in the list box 740 is produced in response to entering a character string in the edit window 710 and pressing one of the buttons 721-723. The matching terms are found by scanning the terms in the termtable and comparing them with the string in the edit window 710. This search is performed using the list_begins_with, list_includes, and list_ends_with methods exported by the texthandler object defined in the textwork.pas unit.

When the terms to be listed are transferred to the “Purple Terms” list box seen at 750, the following routine is performed:

termtable.fonttags.set_tags_from_list(purplebox.items,ft_purple);

kwicbox.clear;

termtable.KWIC_from_tagtable(termtable.fonttags,ft_purple,kwicbox.items);

The first statement calls the “set_tags_from_list” method of the FontTagTable (seen at 460 in FIG. 4), an array of byte values indexed by termnumber which permits a determination to be made of whether a given term has been placed in the Purple list box 750 (or in the Blue list box 830, or in the Green List box 840 shown in FIG. 8 to be discussed below). Calling the “set_tags_from_list” method as shown above, and passing it a pointer (purplebox.items) to the content of the Purple list box 750, populates the FontTagTable 460 for each termnumber for each term in the Purple list box. The kwicbox.clear statement clears the KWIC list display 770. The call to the KWIC_from_tagtable method of the termtable object, passing it a pointer to the font tag table, an constant ft_purple indicating that the “purple terms” are to be listed, and a pointer kwicbox.items to the target window 770, creates the Key Word in Context display in window 770.

The KWIC list display is rapidly produced since, as the array of integers is scanned, each termnumber in the array is used as an index to the font tag table array, so that a rapid determination may be made whether or not the termnumber in the integer array being tested is in the Purple list box. As discussed previously in connection with FIG. 3, the fact that a termnumber can be used to index an array of values which indicate which termnumbers are desired allows searching to be performed at very high speed, producing the substantially instantaneous displays under the “List” tab which would not be possible if it were necessary to using character by character comparisons of every word in the text with every word in a list of desired words.

Moreover, the integer array searching mechanisms made possible by the invention are substantially faster, and much more space efficient, that the use of an inverted file (in which the locations of all words are stored in index files on mass storage). The integer array may be more rapidly searched using the array indexing techniques described than can be achieved by fetching index file data from mass storage—and the substantial computational overhead required to build and maintain the inverted file indices is avoided. Instead of nearly doubling the size of the original text file to provide the needed index files, the size of the data file is compressed by one half. This means that large amounts of data may be stored in limited space. For example, an e-book player using the present invention could store a book library four times as large as would be possible using indexed text files, while providing more rapid and more robust search and display capabilities.

Proximity Searching

As illustrated in FIG. 8, the Flash-Text™ program displays a proximity search interface under the “Search” tab. The user may place any selected term or collection of terms in either the Green List box seen at 830 or the Blue list box seen at 840. In either case, terms are first placed in the Available term list box 860 using the term selection buttons indicated generally at 870 (which in the same way as the mechanism at 710-723 previously described in connection with FIG. 7). The user then selects terms in the available term box 860 and adds those selected terms to either the green or blue list boxes using the buttons 872 and 874 respectively.

As seen generally at 880 in FIG. 3, the user can enter a proximity range and specify whether the Green Terms listed at 830 are to appear before, after, or on either side of the Blue Terms listed at 840. Thus, in the example shown in FIG. 8, when the “Perform Search” button 890 is pressed, a search is conducted through all of the stored text to find any occurrence of the Green Terms which are within six terms on either side of one of the Blue Terms. As each such occurrence is found, the matching text is posted to the KWIC list display which is exposed by automatically displaying the interface under the List Tab as seen in FIG. 7. As before, the user may use the mouse to click on and select any listed line in the KWIC list to view the phrase in context under the Read tab as seen in FIG. 5. The phrase which begins with the first term specified by the proximity search request and ends with the last term is automatically highlighted so that it can be more easily located in the text displayed under the read tab.

Note that the highlighted text displayed as a result of the proximity search is not saved as a persistently stored highlighted block. If the user determines that the proximity search is of interest, the full text of the passage actually of interest may be highlighted in a desired color, made the subject of an user-entered comment, and classified in one or more categories as previously discussed in connection with the Marked Text interface seen in FIG. 6.

Applications

The mechanisms which have been described for representing parsed natural language text as a sequence of integer values may be used to advantage in many applications.

In single processor systems, the use of these techniques permits the storage of data in more compact form, and permits the data to be more rapidly processed. The Flash-Text™ program which has been described above is merely one example of the manner in which the principles of the invention may be employed in a single processor system.

In distributed systems, the representation of data in a more compact format permits the movement of that data via communications facilities at faster rates or with reduced bandwidth, or both. By sharing commonly used stringtables among different datasets, and placing the shared stringtables at different locations, it is unnecessary to transmit the shared tables in order to send the terms in those tables, so that still further reduction in the amount of data that needs to be sent is achieved.

It is to be understood that the specific programs, including particularly the programs listed in the accompanying appendix, are merely illustrative implementations of the invention. Numerous modifications can be made to the specific programs, functions and architectures described without departing from the true spirit and scope of the invention.

What is claimed is:

1. The method of representing natural language text data in encoded form which comprises the steps of subdividing said text data into a sequence of character strings, forming at least one string table containing an addressable copy of each unique one of said character strings, and forming a sequence of integer values each of which specifies a corresponding one of said character strings.

2. The method of representing natural language text data as set forth in claim 1 wherein said sequence of character strings comprises a sequence of alternating natural language terms and punctuation character strings which separate said natural language terms, each of said natural language terms consisting of one or more characters in a first predetermined set of characters that includes the letters of the alphabet, and each of said punctuation strings consists of one or more of characters is a second predetermined set of characters which does not include the letters of the alphabet.

3. The method of claim 2 wherein said first predetermined set of characters further includes the numerical digit characters.

4. The method of claim 2 wherein said first predetermined set of characters includes both the uppercase and the lowercase letters of the alphabet.

5. The method of claim 1 wherein the step of forming a sequence of fixed length integer values includes the step of suppressing the formation of integer values specifying punctuation character strings which consist of a single space character between two of said natural language terms.

6. The method of claim 1 further comprising the step of reconstructing said natural language text data by concatenating the sequence of character strings which correspond to the each integer value in said sequence of integer values.

7. The method of claim 5 further comprising the step of reconstructing said natural language text data by concatenating the sequence of character strings which correspond to each integer value in said sequence of integer values and further comprising the steps of detecting the presence of two consecutive ones of said integer values which represent two adjacent natural language terms, and inserting a single space character between said two adjacent natural language terms.

8. The method of claim 1 wherein said step of forming at least one string table containing an addressable copy of each unique one of said character strings comprises forming a searchable binary tree of nodes, each of said nodes being associated with a unique one of said strings and a unique one of said integer values, comparing in sequence each successive one of said character strings in said text data with the strings associated with the nodes of said binary tree, and forming a new node in said binary tree associated with each new unique character string not already associated with an pre-existing one of said nodes.

9. Apparatus for storing and processing natural language text data consisting of a sequence of encoded characters, said apparatus comprising, in combination,
a parser for subdividing said text data into a sequence of natural language terms and punctuation strings wherein each of said terms consists of characters in a first predetermined set of characters which includes the letters of the natural language alphabet, and wherein each of said punctuation strings consists of characters in a second predetermined set of characters which excludes said letters of the alphabet,
a string lookup storage unit for processing said sequence of term and punctuation strings from said parser and for encoding each given one of said term and punctuation strings as an integer value which uniquely specifies the content of said given one of said term and punctuation strings,
an integer storage unit for storing the integer values from said string storage lookup unit as a sequence of integer values which represent said natural language text, and
means for reproducing said natural language text data in it original form as a sequence of encoded characters by concatenating the terms and punctuation strings whose content is specified by each successive one of said sequence of integer values.

10. Apparatus as set forth in claim 9 wherein said first predetermined set of characters further includes the numeric characters and wherein said second predetermined set of characters excludes said numeric characters.

11. Apparatus as set forth in claim 9 wherein said first predetermined set of characters consists of the upper and lower case letters of the alphabet and numeric characters.

12. Apparatus as set forth in claim 11 wherein each of said term strings consists of characters in said first set of characters as well as one or more specified additional characters provided that two or more of such specified additional characters do not appear adjacent to one another in a term string.

13. Apparatus as set forth in claim 9 wherein said second predetermined set of characters which form the content of said punctuation strings includes the space character and wherein said first predetermined set of characters excludes the space character.

14. Apparatus as set forth in claim 13 including means for omitting from said sequence of integer values stored in said integer storage unit any integer value which represents a single space character, and wherein said means for reproducing said natural language text includes means for responding to the detected presence in said sequence of integer values of any two successive integer values which both specify term strings by concatenating a single space character between the term strings specified by said two successive integer values.

15. The method of processing natural language text which comprises a sequence of terms each of which consists of one or more encoded characters, said method comprising the steps of:
storing each given unique term in said sequence of terms in a first lookup table at a location which is addressable by a unique integer which corresponds to and identifies said given unique term,
employing said first lookup table to convert said sequence of terms into a sequence of corresponding integers,
storing said sequence of corresponding integers in a memory unit,
retrieving said sequence of corresponding integers from said memory unit, and
employing said first lookup table to convert each integer in said sequence of corresponding integers into the term it identifies to reproduce said natural language text.

16. The method of claim 15 further in which said step of employing said first lookup table to convert each integer in said sequence of corresponding integers into the term it identifies to reproduce said natural language text includes the step of concatenating the terms produced by the conversion in the order produced to reproduce said natural language text.

17. The method as set forth in claim 17 further comprising the step of searching said natural language text for one or more specific terms having a predetermined attribute, said step of searching comprising the sub-steps of:
storing an indication of said predetermined attribute in a second lookup table at each location said second lookup table which is addressable by the integer which identifies one of said specific terms,
repetitively retrieving each integer in said corresponding sequence from said memory unit,
employing the retrieved integer to address said second lookup table to produce an output signal whenever said indication of said predetermined attribute was stored in said second lookup table at a location addressed by said retrieved integer, and
utilizing said output signal to specify the location of one of said specific terms in said natural language text.

18. The method as set forth in claim 15 wherein said step of employing said first lookup table to convert said sequence of terms into a sequence of corresponding integers includes, for each given term in said sequence of terms, the steps of:
searching said first lookup table for a previously stored term which matches said given term and, if a matching term is found, converting said given term into the integer which identifies said matching term, and if a matching term is not found, storing said given term in an available empty location in said first lookup table and converting said given term into the integer which addresses said available empty location.

19. The method as set forth in claim 18 further including the step of organizing the terms stored in said first lookup table in a sorted order to facilitate said searching step.

20. The method as set forth in claim 18 wherein each location in said first lookup table is a node of a binary tree comprising a storage location for one of said terms and two branch integer registers, and wherein the step of searching said first lookup table comprises searching said binary tree for the said given term, and wherein said step of storing said given term in an available location is accompanied by the additional step of placing the integer which addresses said available empty location in the branch integer register of the last node found in the course searching said binary tree.
